(19) United States
(12) Patent Application Publication
(10) Pub. No.: US 2018/0045843 A1
(43) Pub. Date: Feb. 15, 2018

(54) Acoustic Imaging with Expandable Microcapsules

(71) Applicant: THE UNIVERSITY OF NORTH CAROLINA AT CHAPEL HILL, Chapel Hill, NC (US)

(72) Inventors: Sergei Sheiko, Chapel Hill, NC (US); Natalia V. Lebedeva, Chapel Hill, NC (US); Aleksandr Zhushma, Durham, NC (US)

(73) Assignee: THE UNIVERSITY OF NORTH CAROLINA AT CHAPEL HILL, Chapel Hill, NC (US)

(21) Appl. No.: 15/551,366

(22) PCT Filed: Feb. 18, 2016
(86) PCT No.: PCT/US2016/018528

§ 371 Date: Aug. 16, 2017

Related U.S. Application Data
(60) Provisional application No. 62/118,003, filed on Feb. 19, 2015.

(51) Int. Cl. G01V 1/42; C09K 8/035; E21B 43/267; C09K 8/70

(52) U.S. Cl. CPC G01V 1/42; C09K 8/70; C09K 8/035; E21B 43/267; E21B 47/101

(57) ABSTRACT

The present disclosure relates generally to expandable microcapsules and their utilization for acoustic imaging within a geological formation. The present disclosure further relates to expandable microcapsules with a multicomponent core and disclosure to practical utilization of multicomponent cores for controlling the expansion properties (e.g., temperature and pressure of expansion, expansion volume ratio, and shell thickness) of the resulting microbubbles.

This application claims priority to U.S. Provisional Application Ser. No. 62/118,003, which is hereby incorporated by reference herein.

### FIELD

The present disclosure relates generally to expandable microcapsules and their utilization for various applications, such as acoustic imaging within a geological formation. The present disclosure further relates to expandable microcapsules with a multicomponent core and disclosure to practical utilization of multicomponent cores for controlling the expansion properties (e.g., temperature and pressure of expansion, expansion volume ratio, and shell thickness) of the resulting microbubbles.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Polymer-shelled microcapsules (“PSMs”) are a versatile class of materials, which can have different applications based on the encapsulated payload. Thermally expandable microcapsules are polymeric core/shell particles in which a volatile liquid is encapsulated by a thermoplastic shell. As the microcapsules are heated, the shell becomes sufficiently soft so that the liquid's (or mixture of liquids) vapor pressure causes the particles to expand. The increased size of the particles is retained upon cooling.

Issues arise with regards to controlling the temperature and pressure at which expansion occurs and the dimensions of the resulting expanded microcapsules. Applicant has identified deficiencies and problems associated with conventional expandable microcapsules and processes for preparing the microcapsules. Through applied effort, ingenuity, and innovation, certain of these identified problems have been solved by developing solutions, which are included in various embodiments of the present disclosure.

### SUMMARY

Embodiments of the present disclosure provide expandable microcapsules and methods of preparing the same. In addition, the present disclosure provides applications for the expandable microcapsules in the fields of oil and/or gas exploration, construction/commodity materials, and biomedical engineering.

In certain embodiments of the disclosure, an expandable microcapsule is provided comprising a polymeric shell and a multicomponent expandable core comprising at least one blowing (expansion) agent, wherein the expandable microcapsule expands at an expansion temperature.

In some embodiments, the blowing agent comprises one or more of hydrocarbons, perfluorocarbons, and organic silanes. In embodiments, the expandable core comprises one or more non-volatile components. As described further, the volatility of the respective component may be relative to the application conditions, including specific temperature, pressure, and/or surrounding liquid (solvent). In certain embodiments, the expandable core comprises two or more blowing agents. In embodiments, the expandable core comprises one or more liquids that are miscible with one or more blowing agents. In some embodiments, the expandable core comprises one or more liquids that are immiscible with one or more blowing agents. In yet additional embodiments, the expandable core comprises one or more pharmaceutical drugs, acids, bases, lubricants, contrast agents, reactive chemicals, density compensators, or combinations thereof.

In certain embodiments, the expansion temperature is from about 50 to about 250° C., while in some embodiments, the expansion temperature is less than about 100° C.

In some embodiments of the present disclosure, a ratio of a volume of the expandable microcapsule after expansion to a volume of the expandable microcapsule prior to expansion ranges from about 30:1.

In some embodiments of the present disclosure, a ratio of a shell thickness of the expandable microcapsule prior to expansion to a thickness of the expandable microcapsule after expansion ranges from about 50:1.

Aspects of the disclosure are also directed to a method of preparing expandable microcapsules. In certain embodiments of the disclosure, the method of preparing expandable microcapsules comprises dispersing two or more liquids with one or more shell monomers in an aqueous solution creating a dispersion, polymerizing the dispersion, and filtering microcapsules formed by the polymerization.

In certain embodiments, the two or more liquids are encapsulated by the polymer. In some embodiments, the two or more liquids are immiscible, while in other embodiments, the two or more liquids are miscible. In embodiments, the two or more liquids comprise one or more volatile liquids and one or more non-volatile liquids. In yet additional embodiments, the non-volatile liquid comprises a pharmaceutical drug, lubricant, contrast agent, reactive chemical, density compensator, or combination thereof. In some embodiments, the multicomponent expandable microcapsules comprise a polymeric shell encapsulating two or more components with at least one component being a blowing agent.

Aspects of the disclosure are directed to systems and methods for acoustically imaging geological reservoirs. In certain embodiments of the disclosure, the systems and methods comprise injecting multicomponent expandable microcapsules into a geological reservoir, propagating sound waves through the geological reservoir, receiving sound waves reflected off the expandable microcapsules, and creating an image of the sound waves reflected off the expandable microcapsules. In some embodiments of the disclosure, the multicomponent expandable microcapsules comprise a polymeric shell encapsulating two or more components with at least one component being a blowing agent.

In certain embodiments, the geological reservoir includes an oil and/or gas wellbore connected to an oil and/or gas-bearing formation. In some embodiments, the systems and methods further comprise dispersing the expandable microcapsules in a fluid. In embodiments, the systems and methods further comprise pressurizing the fluid to create fractures in the oil and/or gas-bearing formation. In certain embodiments, the systems and methods further comprise dispersing the fluid in the fractures created in the oil and/or gas-bearing formation.

Aspects of the disclosure are also directed to various uses of the expandable microcapsules disclosed herein. In certain embodiments, the expandable microcapsules are used as acoustic contrast agents. In some embodiments, the expandable microcapsules are used as acoustic contrast agents in geological reservoirs. In embodiments, the expandable microcapsules are used as acoustic contrast agents in a human body. In yet additional embodiments, the expandable microcapsules are used as a vehicle for pharmaceutical drug delivery. In embodiments, the expandable microcapsules are used as fillers for construction/commodity materials to make light weight and insulation materials (e.g., foams, shoe soles, etc.).

Some of the aforementioned applications may utilize an ability to control the expansion temperature and/or expansion pressure.

These embodiments of the present disclosure and other aspects and embodiments of the present disclosure are described further herein and will become apparent upon review of the following description taken in conjunction with the accompanying drawings.

### BRIEF DESCRIPTION OF THE FIGURES

Reference will now be made to the accompanying drawings, which are not necessarily drawn to scale, and wherein:

FIG. 1A shows an illustration and various images of expandable microcapsules prior to expansion, according to embodiments of the present disclosure;

FIG. 1B shows an illustration and various images of the expandable microcapsules of FIG. 1A after expansion, in accordance with embodiments of the present disclosure;

FIG. 2 illustrates expansion curves of VDC/AN capsules filled with PFH for two different heating rates of 0.12° C./minute and 1.2° C./minute, in accordance with embodiments of the present disclosure;

FIG. 3A shows a Raman spectra of individual polymeric microcapsules, in accordance with embodiments of the present disclosure;

FIG. 3B illustrates an analysis of the representative Raman peaks of FIG. 3A indicating the amount of perfluorohexane and decane in the core as a function of core composition, in accordance with embodiments of the present disclosure;

FIG. 4A shows bright field (left image) and fluorescent (right image) microscopic images showing the locations of decane droplets within a core structure of unexpanded microcapsules, in accordance with embodiments of the present disclosure;

FIG. 4B illustrates an expandable microcapsule prior to expansion (unexpanded), in accordance with embodiments of the present disclosure;

FIG. 4C shows bright field (left image) and fluorescent (right image) microscopic images showing the locations of decane droplets within a core structure of expanded microcapsules, in accordance with embodiments of the present disclosure;

FIG. 4D illustrates an expandable microcapsule after expansion (expanded), in accordance with embodiments of the present disclosure;

FIGS. 5A, 5B and 5C illustrate images and plots showing a variation of the blowing agent content, φ, and its effect on expansion properties of the polymeric microcapsules, in accordance with embodiments of the present disclosure;

FIG. 6A illustrates an expansion curve for perfluoropentane and perfluorohexane, showing that the expansion temperature Tₑₓₚ may change depending on the volatility of the blowing agent, in accordance with embodiments of the present disclosure;

FIG. 6B illustrates a liquid-vapor phase transition diagram for expandable microcapsules comprising PFH and PFP, in accordance with embodiments of the present disclosure;

FIG. 7A illustrates expansion curves of multicomponent cores with the same shell composition and miscible core components;

FIG. 7B illustrates expansion curves of multicomponent cores with the same shell composition and immiscible core components;

FIG. 8 illustrates a flow diagram of acoustic imaging in a geological formation (e.g., utilized for imaging of hydraulic fracturing fluids or injection fluids in a geological reservoir), in accordance with embodiments of the present disclosure; and

FIG. 9 illustrates utilization of expandable microcapsules for acoustic imaging in a geological formation (e.g., utilized for imaging during hydraulic fracturing in a geological reservoir), in accordance with embodiments of the present disclosure.

### DETAILED DESCRIPTION

Embodiments of the present disclosure will now be described hereinafter with reference to the accompanying drawings, in which some, but not all embodiments of the disclosure are shown. Indeed, these embodiments may be embodied in many different forms and should not be construed as limited to the embodiments set forth herein. It is contemplated that any embodiment discussed in this specification can be implemented with respect to any method, kit, reagent, or composition of the invention, and vice versa. Furthermore, compositions of the invention can be used to achieve methods of the invention.

Expandable microcapsules may provide reservoirs for volatile liquids and may be used in a variety of applications. Expandable microcapsules may have only a single blowing (expansion) agent in their cores. Upon application of heat, the polymeric shell softens, and the vapor pressure of the blowing agent forces the polymeric shell to expand. The microcapsule thereby increases in size as the shell of the microcapsule is stretched. A microbubble with increased volume and decreased shell thickness is produced.

The temperature at which the vapor pressure of the blowing agent overcomes the elasticity of the polymeric shell and forces expansion may depend on the polymer shell as well as the blowing agent. Prior to now, the expansion temperature has been dictated by the polymer shell and the blowing agent. The expandable microcapsules are thus limited in the temperatures at which expansion occurs as well as the volume of the microbubble after expansion. Manipulation and control of the expansion temperature and degree of expansion (i.e., the resulting volume of the expandable microcapsules) by modifying the composition of the microcapsule core to include components other than a single blowing agent, such as immiscible liquids, have not been previously known.

Disclosed herein are expandable microcapsules and methods of preparing the expandable microcapsules that allow for control of the expansion temperature, expansion pressure, expansion volume ratio, and expansion shell thickness to provide desired microbubble dimensions under desirable conditions. The dimensions may include radius, shell thickness, and the like. These characteristics of the expandable microcapsules may determine properties of the expandable microcapsules, such as compressibility, buckling stability, echogenicity, release rate of an encapsulated material, and the like. Disclosed herein are expandable microcapsules and processes of preparing the expandable microcapsules with multiple components encapsulated in the microcapsules. In certain embodiments, an expandable microcapsule is provided with a polymeric shell encapsulating one or more volatile liquids that evaporate at different temperatures. In certain embodiments, the expandable microcapsule may comprise a polymeric shell encapsulating one or more volatile liquids as well as one or more non-volatile components, wherein the latter does not have sufficient vapor pressure to expand the shell/particle under conditions of practical utilization.

In certain embodiments, the expansion conditions may depend on the miscibility of one or more of the encapsulated liquids. The miscibility of one or more of the encapsulated liquids may impact the vapor pressure and hence the onset temperature of expansion. As used herein, “expandable microcapsules” refers to a polymeric shell with a liquid and/or solid core, which may expand upon a change in the conditions of the environment. Once expanded, the “expandable microcapsule” is referred to as a “microbubble,” which indicates the core is at least partially in gaseous form. For instance, upon application of heat, the vapor pressure of the core increases and causes expansion of the shell, increasing the volume of the expandable microcapsule to form a microbubble. The polymeric microcapsule may comprise a thermoplastic and elastomeric shell that allows for expansion upon application of heat. Upon cooling, the microbubble may maintain the expanded form. Throughout the disclosure, the shell is referred to as a polymeric shell. The polymeric shell is expandable and, thus, is an expandable shell.

As used herein, “expandable core” refers to the composition encapsulated by the shell of the expandable microcapsule. The expandable core may comprise a variety of components with at least one of the components being a blowing agent. As used herein, the interchangeable terms “blowing agent” and “expansion agent” refer to any liquid or gas that has sufficient vapor pressure to expand or inflate the microcapsule shell after it has softened. The volatility of the relevant liquid is relative to the particular application and the temperature used for that application. For instance, in certain embodiments, a liquid may be considered a volatile liquid, as it vaporizes under the specific temperature, pressure, and surrounding liquid (solvent) of the embodiment, while in other embodiments, the liquid may be considered a non-volatile liquid, as it does not vaporize under the specific temperature, pressure, and surrounding liquid (solvent) of the embodiment. With this in mind, components of the expandable core, as well as the temperature and pressure conditions, can be modified to achieve desired microbubbles (for instance, in terms of core composition, shell thickness, volume, etc.) under desirable conditions using methods of the present disclosure.

The “expansion temperature” refers to the temperature at which the expandable microcapsule starts expanding. In certain embodiments of the disclosure, the expansion temperature may depend on various factors, such as amount and composition of the microcapsule shell, amount and composition of the expandable core, external pressures, and the like. The “expansion pressure” refers to the pressure inside the core, while the external is at atmospheric pressure, at which the expandable microcapsule starts expanding. The “expansion volume ratio” refers to the ratio of the volume of the expandable microcapsule after expansion to the volume of the expandable microcapsule prior to expansion. The expansion volume ratio may be referred to as V/V₀ where V equals the volume of the expandable microcapsule after expansion, and V₀ equals the volume of the expandable microcapsule prior to expansion (the initial volume). The “expansion thickness ratio” may be referred to as h₀/h where h₀ equals the shell thickness of the expandable microcapsule prior to expansion (initial shell thickness), and h equals the shell thickness of the expandable microcapsule after expansion.

As used herein, “expandable” refers to the ability of a microcapsule to expand. As used herein, “expand” refers to the change in volume, which can be described by the aforementioned expansion volume ratio V/V₀.

As used herein, “miscible” refers to components that form a homogeneous mixture, while “immiscible” refers to components that are not able to form a homogeneous mixture.

Various applications for the use of the expandable microcapsules of embodiments of the present disclosure are provided. As used herein, the term “borehole” refers to a shaft bored in the ground vertically, horizontally, and/or diagonally. Boreholes are often used for geological investigation and may be used for extraction of natural resources such as water, oil, gas, and the like. The term “wellbore” refers more specifically to a borehole used for extraction of natural resources such as water, oil, gas, and the like. The term “oil and/or gas-bearing formation” refers to an area typically under the Earth's surface that is a source for oil and/or natural gas. The formation may be located thousands of feet below the Earth's surface.

As used herein, the term “fluid” refers to a gas or liquid substance. The term “acoustic imaging” refers to the use of sound waves that reflect off objects or transmit through objects to create images of the targeted area.

The expandable microcapsules of embodiments of the present disclosure may have various applications such as in the biomedical field (e.g., ultrasound imaging or drug delivery), construction materials (e.g., in foams, insulation, and other building materials), textiles (e.g., in clothes and shoes as insulation), and other composites. The microcapsules may provide density reduction, thermal insulation, acoustic insulation/modification, and other benefits. Depending on the amount and embodiment of microbubbles used, the properties of acoustic waves propagating through materials can be modified, such as the intensity, speed, and frequency.

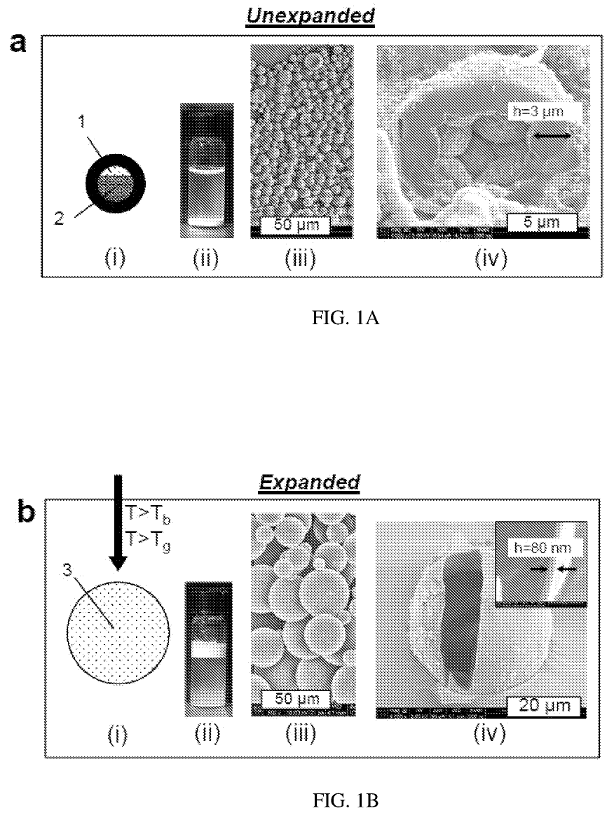

FIGS. 1A-1B illustrate and example of expansion of an expandable microcapsule comprising a single blowing agent. As shown in FIGS. 1A-1B, expansion of expandable microcapsules may occur when the microcapsules are heated above the boiling temperature of the expandable core and the glass transition temperature of the shell material. FIG. 1A illustrates various views of expandable microcapsules prior to expansion, according to embodiments of the present disclosure, while FIG. 1B illustrates analogous views of the expandable microcapsules, or microbubbles after expansion. Illustration (i) of FIG. 1A depicts an expandable microcapsule comprising an expansion agent 2 (e.g., a liquid blowing agent; e.g., perfluorohexane), according to embodiments of the disclosure. The microcapsule may also contain some gas 1 trapped during its synthesis. Illustration (i) of FIG. 1B illustrates the microcapsule of illustration (i) of FIG. 1A after expansion. As shown in illustration (i) of FIG. 1B, after expansion, the expandable microcapsule of illustration (i) of FIG. 1A comprises the blowing (expansion) agent 3 in gaseous form. Image (ii) of FIG. 1A shows the expandable microcapsules in water prior to expansion, and image (ii) of FIG. 1B shows the expandable microcapsules in water after expansion. As shown by comparing the two images, the density of the microcapsules decreases after expansion. Image (iii) of FIG. 1A is a scanning electron microscopy (“SEM”) image of the expandable microcapsules prior to expansion, according to embodiments of the disclosure. Image (iii) of FIG. 1B is a SEM image of the expandable microcapsules after expansion, according to embodiments of the disclosure. These images illustrate increases in sizes of the microcapsules after expansion from about 10 microns to about 50 microns. Image (iv) of FIG. 1A is a SEM image of focused ion beam (“FIB”) milled particles prior to expansion. Image (iv) of FIG. 1B is a SEM image of FIB milled particles after expansion. These images illustrate decreases in shell thicknesses (h) in the microcapsules after expansion from about 3 microns (i.e., h=3 μm) to about 80 nm (i.e., h=80 nm).

As shown in FIGS. 1A-1B, expansion may occur when a microcapsule containing a liquid blowing agent 2 is heated to a temperature (T) above the boiling temperature of the core liquid T_{b} (i.e., T>T_{b}) and the glass transition temperature of the shell material T_{g} (i.e., T>T_{g}), inflating the microcapsule into a microbubble filled with gas 3 and with a larger diameter.

Embodiments of the present disclosure provide methods for modifying and controlling the temperature at which expansion occurs, as well as the expansion volume ratio of the expandable microcapsules. Certain embodiments of the present disclosure provide a simple, scalable, one-step suspension polymerization with near quantitative yield, allowing for multiple component encapsulation. Without intending to be bound by theory, by encapsulating different types of liquids (miscible and/or immiscible) and controlling the molar fractions of the liquid inside the core, the expansion volume ratio and expansion temperature may be controlled within broad ranges. The variety of industrial applications in which the microcapsules may be used thus greatly increases.

A. Multicomponent Expandable Microcapsules

In certain embodiments, the expandable microcapsules may be synthesized using suspension polymerization. The one or more blowing agents are encapsulated inside the polymeric shell. In embodiments of the disclosure, an organic phase comprising shell monomers and one or more blowing agents are dispersed in an aqueous phase to form a microemulsion. In certain embodiments, the aqueous phase may comprise additives, such as stabilizers and surfactants. Stabilizers may prevent or mitigate coalescence of the microemulsion droplets after mixing and dispersion but prior to heating. Suitable stabilizers include water soluble organic polymers, such as polyvinyl alcohol or polyvinyl pyrrolidone, or inorganic particles such as silica, magnesium hydroxide, and magnesium chloride. The stabilizers may be added in any suitable amount, such as from about 1 mol/L-0.05 mol/L. For instance, the stabilizers may be added in amounts such as about 0.5 mol/L, 0.4 mol/L, 0.3 mol/L, 0.2 mol/L, 0.1 mol/L, 0.05 mol/L, or less. The amount of stabilizer may be determined to keep the organic and water phase from separating quickly. For instance, about 0.3 mol/L of Mg(OH)₂ may be added. Surfactants may be added to aid in the formation of the microemulsion by enhancing wettability of the stabilizer, promoting its adsorption to the outer surface of the emulsion droplet. Suitable surfactants include sodium 2-ethylhexyl sulfate. In the case when a shell monomer is used that has some water solubility, it may be desired to prevent the monomer from polymerizing in the water phase, but preferentially that it polymerizes in the oil droplets (organic phase). To prevent polymerization in the water phase, a water-soluble inhibitor may be used, such as potassium dichromate or sodium nitrite. The water-soluble inhibitor may be added in any appropriate amount, such as less than about 6 mM, 5.5 mM, 5 mM, 4.5 mM, 4 mM, 3.5 mM, 3 mM, 2.5 mM, 2 mM, 1.5 mM, 1 mM, or less. For instance, about 3.6 mM of potassium dichromate may be used.

The shell monomers may be any suitable monomer or combinations of monomers capable of expanding or stretching upon application of heat. Suitable shell monomers may be acrylonitrile (“AN”), vinylidene chloride (“VDC”), styrene, acrylic acid (“AA”), methacrylonitrile (“MAN”), methyl methacrylate (“MMA”), methyl acrylate (“MA”), glycidyl methacrylate (“GMA”), ethylene glycol dimethacrylate (“EGDMA”), other acrylates and methacrylates, and combinations thereof. Acrylonitrile may exhibit excellent gas-barrier properties, yet, relatively poor heat resistance. See U.S. Pat. No. 3,615,972; M. Jonsson et al., Eur. Polym. J. 2009, 45, 2374; M. Jonsson et al., J. Appl. Polym. Sci. 2010, 117, 384; P. Griss et al., Lab Chip 2002, 1, 117; and Y. Kawaguchi et al., Polym. Eng. Sci. 2009, 50, 835, which are all incorporated by reference herein. Certain embodiments may use copolymers of acrylonitrile with other monomers, such as vinylidene chloride (“VDC”) and methacrylonitrile (“MAN”), to ensure preparation of robust microbubbles. The mechanical and gas-permeability properties of microbubbles can become increasingly important with thin-shelled microbubbles.

The polymerization may proceed in one or more steps to encapsulate the core components in the polymer shell. In some embodiments, the polymerization may be a one-step polymerization that encapsulates the core components in the polymeric shell. Polymerization may proceed at about 63° C. for about 12 hours in a constant volume vessel. Depending on the rate of reaction, polymerization may proceed at about 50° C.-150° C. for about 5 minutes to 24 hours, or longer, with the time limited by the degradation temperature of the reactants. Polymerization may be started at about 1 atm, but can proceed at higher pressures, such as about 300 atm.

The polymeric shell may comprise one or more layers. The one or more layers may each comprise thermoplastic components that expand upon heating. The polymeric shell may be modified to obtain certain desired surface properties or to enhance certain properties of the expandable microcapsules. For instance, crosslinking agents may be included in the polymerization reaction to provide crosslinked polymers. The polymeric shell may also be coated with a material to impart desired characteristics to the resulting microbubbles.

In some embodiments, the organic phase may comprise about 70% by volume shell monomers and 30% core components (volume may exclude the minute volume that the initiator takes up, which may be about 1% the weight percent of the volume of monomers). The ratio of shell monomers to core components may be from about 99:1 to about 1:99, and in any proportion in between. The amounts of shell monomers and core components as well as the ratio of the two can be adjusted and tuned to obtain desired properties, such as shell thickness, expansion temperature, expansion volume ratio, and the like. In certain embodiments, to enable an expansion process, the microcapsules may have a significant fraction of a liquid core. In some embodiments, if the shell is too thick, expansion may not occur. See M. Zhou et al., “Confinement of Acoustic Cavitation for the Synthesis of Protein-Shelled Nanobubbles for Diagnostics and Nucleic Acid Delivery,” ACS Macro Lett, 2012, 1, 853-856, which is hereby incorporated by reference herein. In certain embodiments, the core may also contain a certain minimum amount of a blowing agent as part of the core components.

The blowing agent may be any suitable liquid that creates sufficient vapor pressure to expand or inflate the microcapsule shell after the shell has softened. For instance, the blowing agent may be volatile hydrocarbons, halogenated hydrocarbons, organic silanes, or mixtures thereof. Suitable volatile hydrocarbons include ethane, ethylene, propane, propene, butane, isobutene, neopentane, acetylene, isopentane, decane, hexane, heptane, and the like. Suitable halogenated hydrocarbons include chlorofluorocarbons, such as trichlorofluoromethane, dichlorofluoromethane, chlorotrifluoromethane, and the like, and perfluorocarbons, such as perfluorohexane, perfluoropentane, perfluorooctane, and the like. Suitable volatile organic silanes include tetramethylsilane, and the like. In certain embodiments, the blowing agent may be hydrophobic, such as isopentane. In some embodiments, the blowing agent may be hydrophobic, as such may be less likely to leak through the polymer shell into an aqueous environment.

The blowing agent may be present in the expandable core in any amount sufficient to create enough vapor pressure to force the polymeric shell to expand. The amount of blowing agent needed to trigger expansion may vary depending on the polymeric shell properties. The blowing agent may comprise about 0.01% by volume to about 100% by volume of the expandable core. In certain embodiments, more than one blowing agent may be present. In such embodiments, the combination of the one or more blowing agents may comprise about 0.01% by volume to about 100% by volume of the expandable core. Suitable amounts of the one or more blowing agents are about 1%, 5%, 10%, 15%, 20%, 25%, 30%, 35%, 40%, 45%, 50%, 55%, 60%, 65%, 70%, 75%, 80%, 85%, 90%, 95, and 99% by volume of the expandable core.

After polymerization, the microcapsules may be recovered by any suitable method, such as by filtration. The expandable microcapsules may then be further modified, such as with a coating, or may be used directly in a variety of industrial applications.

In certain embodiments, one or more blowing agents may be included in the expandable core. In some embodiments, a plurality of blowing agents may be included in the expandable core. The plurality of blowing agents may be selected and designed to modify and control the expansion properties, such as expansion temperature and/or expansion volume ratio. In certain embodiments, the blowing agents may be miscible or immiscible liquids. For instance, miscible liquids perfluoropentane, perfluorohexane, and/or perfluorooctane may be used as the blowing agents in the expandable core. In some embodiments, immiscible liquids, such as perfluoropentane and isopentane, may be used as the blowing agents in the expandable core. Still further, one or more miscible liquids may be used along with one or more immiscible liquids in the expandable core. Due to the chemical dissimilarity of immiscible liquids, the liquids would be expected to seek separate microcapsules. However, embodiments of the present disclosure provide methods of preparing expandable microcapsules comprising two or more immiscible liquids within a single microcapsule.

In certain embodiments, a non-volatile component may be included in the expandable core. The non-volatile component may be miscible or immiscible with the one or more blowing agents. In certain embodiments, the non-volatile component may be any suitable liquid with a low vapor pressure under the applicable conditions. The non-volatile component may be present in an amount such as about 0.01% by volume to 99.99% by volume of the expandable core. In certain embodiments, more than one non-volatile component may be present. In such embodiments, the combination of the non-volatile components may be present in about 0.01% by volume to 99.99% by volume of the expandable core. Suitable amounts of the one or more non-volatile component are about 1%, 5%, 10%, 15%, 20%, 25%, 30%, 35%, 40%, 45%, 50%, 55%, 60%, 65%, 70%, 75%, 80%, 85%, 90%, 95%, and 99% by volume of the expandable core. In certain embodiments, with a non-volatile liquid in the expandable core, the expansion volume ratio can be controlled by varying the molar fraction of the volatile liquid.

The options available for the non-volatile component are not limited nor are the combinations of the non-volatile components. The non-volatile component may be any additive or active agent. For instance, the non-volatile component may be a lubricant, acid, pharmaceutical drug, contrast agent, or other material with a low vapor pressure.

B. Expansion of Multicomponent Expandable Microcapsules

In certain embodiments of the disclosure, the onset of expansion may correspond to a system where the internal pressure (Pᵢₙ) exceeds the sum of the external pressure (Pₑₓₜ) and the restoring pressure (Pₑₗ) due to shell expansion (i.e., Pᵢₙ>Pₑₓₜ+Pₑₗ). As such, the expansion temperature may depend on shell properties (for instance, thickness, radius, modulus, and the like) and the core composition (for instance, vapor pressure, miscibility between the core components, and the like). Modifying either the polymer shell or the core composition may adjust the expansion temperature. In the present disclosure, methods are provided for changing the expansion temperature as well as the expansion volume ratio by modifying the core composition. The present disclosure provides methods of preparing multicomponent expandable cores that allow for manipulation and control of the expansion temperature and expansion volume ratio. In certain embodiments, an expandable microcapsule may be formed with a desired shell thickness and radius at lower temperatures.

In certain embodiments of the disclosure, by controlling the expansion volume ratio, the shell thickness and compressibility can be controlled. By reducing the volume fraction of the blowing agent (which in some embodiments, increases the fraction of the non-volatile component) the expansion volume ratio of the microcapsule can be manipulated. Microbubbles with thicker or thinner shells as compared to conventional techniques can be produced.

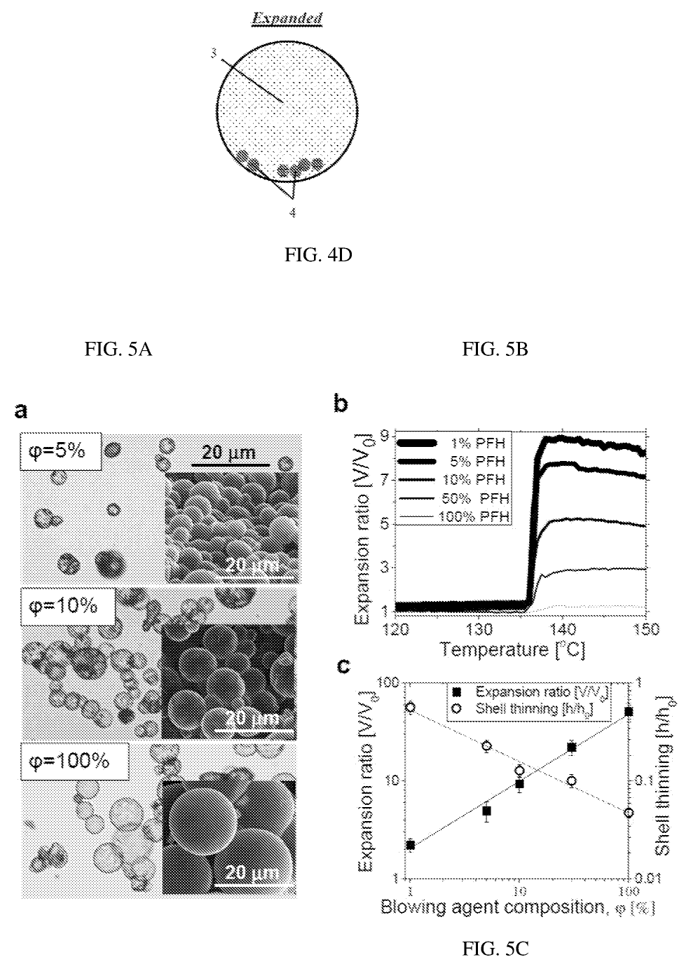

In certain embodiments, as the amount of the one or more blowing agents increases, the expansion volume ratio increases and the shell thickness decreases. As previously mentioned, the “expansion volume ratio” refers to the ratio of the volume of the expandable microcapsule after expansion to the volume of the expandable microcapsule prior to expansion. The expansion volume ratio may be referred to as V/V₀ where V equals the volume of the expandable microcapsule after expansion, and V₀ equals the volume of the expandable microcapsule prior to expansion. In certain embodiments, the expansion volume ratio (V/V₀) may be from about 50:1, from about 40:1, or about 30:1. Suitable expansion volume ratios may be about 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30. FIG. 5B illustrates an example of a variation of the blowing agent content, φ, and its effect on expandable properties of the polymeric microcapsules, such as the expansion volume ratio (V/V₀). In the embodiments of FIG. 5, the blowing agent content is about 1%, 5%, 10%, 50%, and 100% perfluorohexane (“PFH”) with the remainder comprising n-decane, a liquid with a relatively low vapor pressure. As shown in FIG. 5B, as the amount of blowing agent increases, the expansion volume ratio increases as well (the lines in the plot represent the blowing agent content of about 1%, 5%, 10%, 50%, and 100% PFH, with the thinnest line representing the 1% PFH and the thickest line representing the 100% PFH, with the other percentages increasing with the increasing thickness of the plot lines).

The expansion volume ratio may be modified to obtain a desired shell thickness. In certain applications of the present disclosure, certain shell thicknesses may be desired. For instance, when the expandable microcapsules are used in highly pressurized systems, a thicker shell may be desired to withstand the external pressure. In systems under a lower pressure, a thinner shell may be all that is needed. The shell thickness may depend on the type of shell material, the temperature the microcapsules are heated to, the sphericity of the shell, deformations in thickness, and other aspects of the microcapsule and conditions the microcapsule is under. The required thickness for a given application may be determined experimentally for a particular application.

The relationship of the expansion temperature (and corresponding vapor pressure) and the initial shell thickness and radius can be seen in the following example. In theory, assuming a perfect sphere, the vapor pressure to deform the shell may be determined. The restoring pressure (Pₑₗ) of a rubber-elastic shell is a function of h₀/R₀, where h₀ is the initial shell thickness and R₀ is the initial shell radius:

$${P}_{el} ≅ 2 G \frac{{h}_{0}}{{R}_{0}} ( \frac{1}{λ} - \frac{1}{{λ}^{7}} )$$

wherein G is the shear modulus of the shell, and λ is the shell extension ratio.

The following are examples of expansion temperature (and corresponding vapor pressure) dependence on h₀/R₀:

These h₀/R₀ variations resulted in a shift of the following expansion temperatures: Tₑₓₚ=150° C. (13.5 atm) for h₀/R₀=0.22; Tₑₓₚ=140° C. (10.4 atm) for h₀/R₀=0.17; and Tₑₓₚ=139° C. (9.2 atm) for h₀/R₀=0.15.

In some embodiments, the expansion thickness ratio (h₀/h) may range from about 50:1, such as from about 40:1, or about 30:1, and any ratio in between.

In systems with a single blowing agent, expansion generally may occur at temperatures greater than the glass transition temperature of the shell composition and the boiling temperature of the blowing agent. With expandable cores comprising a single component, the expansion temperature may be significantly higher than the glass transition temperature of the shell composition and the boiling temperature of the blowing agent. In certain embodiments of the disclosure, the expansion temperature may be lowered by using multicomponent expandable cores. Without intending to be bound by theory, the chemical similarity of the one or more components in the expandable core may impact the expansion temperature and allow for a lower expansion temperature. With multicomponent expandable cores, expansion may be triggered at a wider range of temperatures than with single component expandable cores. The core composition can be modified to tune the expansion temperature to a desired temperature within a wider range of possibilities and allow for control of the expansion process.

In some embodiments, the expandable core may comprise one or more miscible liquids, while in other embodiments, the expandable core may comprise one or more immiscible liquids. In yet other embodiments, the expandable core may comprise both miscible liquids and immiscible liquids within the microcapsule. In certain embodiments of the disclosure, particularly in those embodiments utilizing miscible liquids within the expandable core, the expansion temperature may be between the corresponding temperatures of the neat liquids. Following Raoult's law, which states that the total vapor pressure of an ideal solution is directly dependent on the vapor pressure of each chemical component and the mole fraction of the component present in the mixture, the vapor pressure of the mixture may be the molar average of the miscible liquids. The expansion temperature may fall within the bounds of the corresponding temperatures of the neat liquids, and can be modified by adjusting the molar fraction of each miscible liquid. The variation of core composition by altering the fraction of two or more miscible components may allow for tuning of the expansion temperature.

In certain embodiments of the disclosure, particularly in those embodiments utilizing immiscible liquids within the expandable core, the expansion temperature may be lower than the temperature of expansion of the neat liquids. In certain embodiments, the core composition can be modified to obtain expansion temperatures much lower than the expansion onsets of the respective neat liquids. Following Dalton's law, where the partial pressure of a component is equal to the vapor pressure of the pure component, the vapor pressure in the expandable core may be the sum of the vapor pressures of the pure components. For instance, Pₜₒₜₐₗ=P_{A}^{°}+P_{B}^{°}, where P_{A}^{°} and P_{B}^{°} are the vapor pressures of pure A and pure B. In certain embodiments, with immiscible liquids, the expansion temperature may not depend on the relative amounts of the immiscible liquids. In certain embodiments, when the immiscible liquid is non-volatile, the expansion temperature may not depend on the loading of the non-volatile component.

In certain embodiments of the disclosure, the expansion temperature may be controlled to utilize a desired expansion temperature. For instance, the expansion temperature may be manipulated to fall within the range of about 50° C.-250° C., such as within about 60° C.-225° C., or about 60° C.-190° C. By modifying the composition of the expandable core, the expansion temperature can be tuned to a desired temperature. In certain embodiments, the expandable core may be designed to have an expansion temperature of less than about 190° C., less than about 180° C., less than about 170° C., less than about 160° C., less than about 150° C., less than about 140° C., less than about 130° C., or less than about 120° C., such as less than about 100° C. In certain other embodiments, the expandable core may be designed to have an expansion temperature of greater than about 200° C., such as greater than about 210° C., greater than about 220° C., greater than about 230° C., or greater than about 240° C. For instance, the expandable core may be designed to have an expansion temperature of about 230° C. In such embodiments, the polymeric shell may comprise acrylonitrile (“AN”) and acrylic acid (“AA”). The expandable microcapsules of the present disclosure thereby enable expansion to occur at lower temperatures.

Embodiments of the present disclosure provide methods for preparing expandable microcapsules encapsulating multiple components, such as two chemically different liquids (for instance, immiscible liquids), within a single core at a given stoichiometric ratio. In certain embodiments, a one-step suspension polymerization can be used to encapsulate the multiple components.

In certain embodiments, the inclusion of a second component, in addition to the blowing agent, can dramatically expand the range of applications of gas-filled polymeric microcapsules. In certain embodiments, the blowing agent can be used to decrease density, increase size, and/or enhance echogenicity, while in some embodiments, a non-volatile component can be used for complementary functions, such as pharmaceutical drug or material delivery. In addition, the presence of the non-volatile component can tune the expansion volume ratio and/or expansion temperature. The concurrent activation and complementarity can thereby enable a broad range of practical applications. Further, in certain embodiments, an expandable microcapsule may be used where the blowing agent comprises only a small fraction of the expandable core. For instance, in certain embodiments, such as those utilizing immiscible liquids, the blowing agent may comprise about 1% by volume of the expandable core, with the second component comprising the remaining core. In certain embodiments, the expandable core may comprise up to about 99% by volume of non-volatile component.

Certain embodiments of the disclosure provide a facile route to tunable, polymeric microcapsules containing a gas and one or more non-volatile components. The microcapsules may perform multiple, simultaneous functions for a number of applications. The expandable microcapsules may deliver pharmaceutical drugs, acids, bases, lubricants, radiographic contrast agents, reactive chemicals (e.g., cross-linkers, gelation inducing agents, reduction agents, catalysts), density compensators, and the like, which can be released upon changes in pH, temperature, mechanical stress, and/or application of ultrasound. Due to the high compressibility of expandable microcapsules of certain embodiments of the disclosure, the microcapsules may be used as density attenuators and acoustic contrast agents. For instance, the microcapsules may be used for multifunctional applications, such as acoustic navigation of chemical delivery or dual imaging: CT and acoustic. The expandable microcapsules of the present disclosure may find applications in the fields of pharmaceutical drug delivery, acoustic imaging, enhanced oil recovery, drilling, construction, self-healing materials, and a wide range of other possible fields.

For instance, in certain embodiments where the non-volatile cargo comprises a pharmaceutical drug, expandable polymeric microcapsules containing a gas and the drug may be formed. The expandable microcapsules are more stable than lipid stabilized microcapsules developed by other groups. See E. Unger et al., Invest. Radiol., 1998, 33, 886; E. Schutt et al., Angew. Chem. Int. Ed., 2003, 42, 3218; J. R. Eisenbrey et al., J. Controlled Release, 2010, 143, 38; and M. S. Tartis et al., Ultrasound in Med. and Biol., 2006, 32, 1771, which are all incorporated by reference herein.

In certain embodiments, the expandable microcapsules may be used in construction. The expandable microcapsule may be used to provide certain desired characteristics to construction materials. For instance, in embodiments, the expandable microcapsules of the present disclosure may be added to cement to create porous cement with lower density while maintaining the strength of the material.

In certain embodiments, the microcapsules may be used for self-healing materials. It may require a large amount of force to rupture a microcapsule with an incompressible liquid core. To solve this problem, researchers have developed hollow particles that are vacuum infiltrated to produce a particle that is only partially filled with liquid. See H. Jin et al., Polymer, 2012, 2, 581, which is hereby incorporated by reference herein. However, this process requires several steps and has, at each step, a portion of unsuccessful microcapsules that are removed. Thermal expansion of a microcapsule containing a liquid for self-healing in accordance with the present disclosure may provide an easier and more efficient route to partially filled microcapsules of a desired composition.

In certain embodiments, the expandable microcapsules may be used as acoustic contrast agents. The expandable microcapsules may be introduced into a target media and, in some embodiments, a transducer may be used to convert electrical energy to sound waves that are transmitted through the target media. The sound waves are reflected when there is an acoustic impedance change, such as a difference in density. The sound waves echo back to the transducer, which detects the echo, converts the echo to electrical energy, and provides such to a scanner, which produces an image from the information. The intensity of the echo as well as the length of time for the sound wave to travel back to the transducer after transmission impact the resulting image. The expandable microcapsules of the present disclosure can be modified and adjusted to meet the needs for any application of acoustic contrast agents. By modifying the core composition, e.g., the ratio of volatile to non-volatile components and/or the presence of immiscible and miscible liquids, the expandable microcapsules may be designed to enhance certain properties of the expandable microcapsules. For instance, methods disclosed herein may allow for adjustment of the expansion temperature, expansion volume ratio, density, volume, shell thickness, and other characteristics of the expandable microcapsules thereby providing designer microcapsules suitable for a wide range of applications.

In certain embodiments, the blowing agent disclosed herein may allow for ultrasound-triggered pharmaceutical drug release while also enhancing acoustic imaging contrast. The expandable microcapsules of the present disclosure may be used to enhance the contrast of soft and hard tissues and allow for targeted pharmaceutical drug release. Using methods disclosed herein, microbubbles may be made with thicker shells allowing for more resistance to ultrasound.

In certain embodiments, the expandable microcapsules may be administered intravenously. In some embodiments, the expandable microcapsules may be used to image blood flow, blood perfusion, interfaces between blood and tissue, interfaces between soft and hard tissues, and the like. In some embodiments, the expandable microcapsules may be used for diagnostic purposes. In some embodiments, the expandable microcapsules may be designed to target organs or cells. In some embodiments, the expandable microcapsules may be used in echocardiography.

The frequencies used for the acoustic imaging may vary depending on the need and application. For instance, the frequency of the sound waves may vary depending on the desired depth of penetration and the degree of detail desired in the resulting images.

In certain embodiments, the expandable microcapsules may be used in a geological formation (e.g., a reservoir) for acoustic imaging. The expandable microcapsules may be used in any type of geological formation for imaging using geological formation imaging techniques. For instance, the geological formation may be drilled for oil and/or gas, groundwater, mineral, and geothermal exploration or environmental or geotechnical studies. In certain embodiments of the present disclosure, expandable microcapsules with thicker and more robust shells may be produced. These microcapsules may be suitable for injecting in geological formations with a wide range of depths.

In certain embodiments, the expandable microcapsules may be used in oil and/or gas drilling activities such as water flooding and hydraulic fracturing. Water flooding is often used to increase pressure in a well. Water may be injected into the wellbore to replace removed oil or gas in an oil and/or gas-bearing formation, thereby increasing the pressure in the well and stimulating production. Hydraulic fracturing may also be used for well stimulation. Highly pressurized fluid comprising water, sand, air, and the like are pumped down a wellbore and into the oil and/or gas-bearing formation to create cracks or fractures throughout the formation. The proppants (e.g., sand and other solid materials in the pressurized fluid) keep the fractures open. The fractures release pressure allowing hydrocarbons to flow up a wellbore to be collected.

The expandable microcapsules of the present disclosure may be used as acoustic contrast agents to disperse in injection fluids or fracturing fluids to track the fluid. Wellbores may be around 10,000 ft. deep and may be onshore or offshore wells. As the expandable microcapsules travel down a wellbore, the temperature and pressure increase. Techniques disclosed herein may allow for control of the shell thickness by modifying the core composition thereby creating more robust microbubbles. Expandable microcapsules of embodiments of the present disclosure may be made to withstand the increase in pressure and allow for expansion as the temperature increases in the wellbore. As the microcapsules expand, the microcapsules become acoustically active and can be used to enhance the contrast between water, oil, and other materials in the oil and/or gas-bearing formation. Expandable microcapsules of embodiments of the present disclosure may allow for acoustic imaging of the injected fluids as the fluids move through the wellbore and oil and/or gas-bearing formation. The expandable microcapsules can allow for mapping of the fractures created in the oil and/or gas-bearing formation.

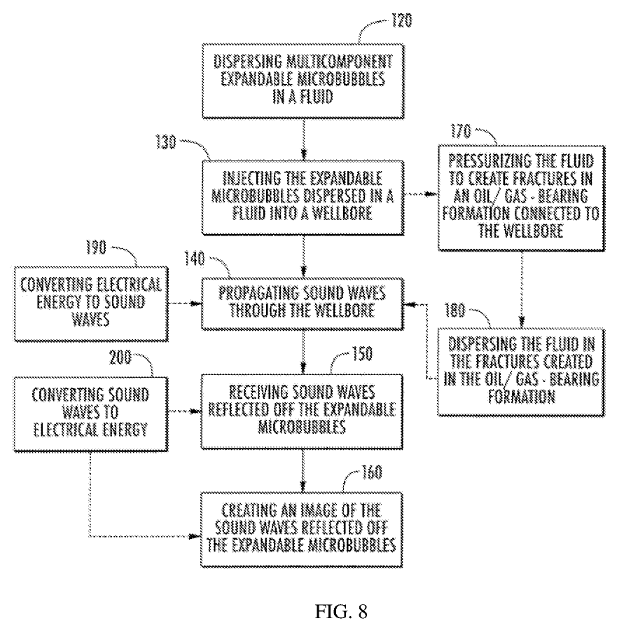

Embodiments of the present disclosure provide systems and methods for acoustically imaging an oil and/or gas-bearing formation with the expandable microcapsules. Some embodiments of the disclosure provide systems and methods for acoustically imaging fracturing fluid or injection fluid in an oil and/or gas-bearing formation. FIG. 8 illustrates a flow diagram of systems and methods for acoustically imaging fracturing or injection fluids in accordance with embodiments of the present disclosure. In block 120, expandable microcapsules disclosed herein are dispersed in a fluid. In block 130, the expandable microcapsules dispersed in the fluid are injected into a geological formation. In block 140, sound waves are propagated through the geological formation. In block 150, sound waves reflected off the expandable microcapsules are received, sensed, or otherwise measured. In block 160, an image of the sound waves reflected off the expandable microcapsules is created utilizing well-known techniques and equipment.

In certain embodiments, the fluid may be fracturing fluid. In some embodiments, such as illustrated in FIG. 8, acoustically imaging fracturing fluids may further comprise pressurizing the fluid to create fractures in an oil and/or gas-bearing formation connected to the wellbore (block 170) and dispersing the fluid in the fractures created in the oil and/or gas-bearing formation (block 180). The image of the sound waves received from sound waves reflecting off the expandable microcapsules in the fractures of the oil and/or gas-bearing formation may provide a map of the fractures in the oil and/or gas-bearing formation. In addition, acoustically imaging fracturing or injection fluids may additionally comprise converting electrical energy to sound waves (block 190) and converting sound waves to electrical energy (block 200). These operations may be performed with the help of a transducer.

Acoustically imaging an oil and/or gas-bearing formation with the expandable microcapsules disclosed herein may be performed by a variety of well-known techniques without deviating from the aspects of the present disclosure. Acoustically imaging other reservoirs or receptacles for fluid (e.g., gas and/or liquid) can similarly be performed by a variety of well-known techniques without deviating from the aspects of the present disclosure.

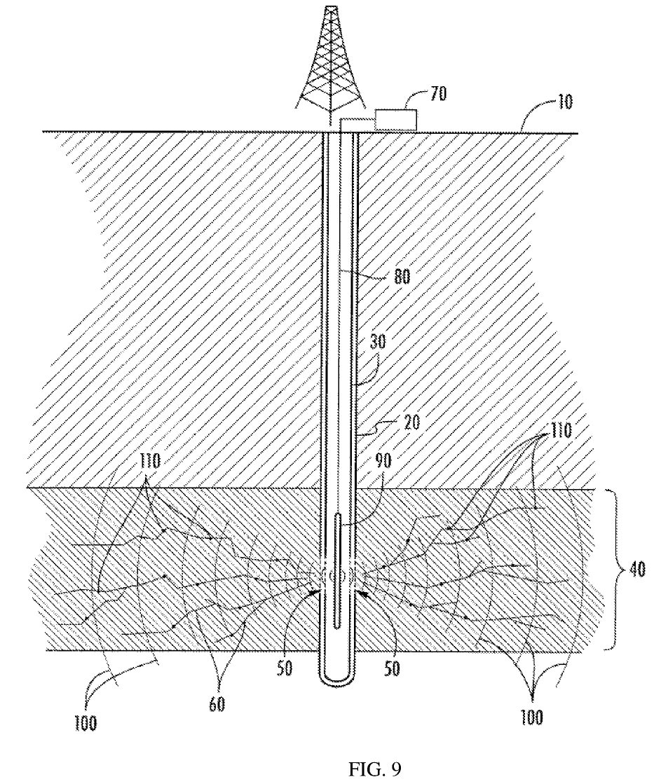

FIG. 9 illustrates an exemplary use of expandable microcapsules for acoustic imaging in a geological formation (e.g., with respect to enhanced oil recovery (e.g., hydraulic fracturing)), in accordance with embodiments of the present disclosure. In FIG. 9, a casing 30 may be formed in a wellbore 20 drilled beneath the Earth's surface 10 (e.g., to collect oil and/or gas from an oil and/or gas-bearing formation 40). A casing is typically a pipe inserted in the wellbore 20 and held in place by cement. As shown in FIG. 9, the casing 30 may comprise perforations (or holes) 50 exposing the interior of the casing 30 to the formation 40. In embodiments, the expandable microcapsules 110 are dispersed in fracturing fluid and travel down the wellbore 20 to the formation 40. The fracturing fluid may be pressurized to create fractures 60 in the oil and/or gas-bearing formation 40 as the fluid exits the casing 30 and enters through the perforations 50 into the formation 40. As shown in FIG. 9, a wireline 80 may be introduced into the wellbore 20. The wireline 80, which may be introduced from a wireline spool 70, may comprise a logging tool 90 that houses sensors used to measure properties of the oil and/or gas-bearing formation 40. The logging tool 90 may comprise a transducer that sends sound waves 100 out through the formation 40, which are reflected off the expandable microcapsules 110 located in the fractures 60. Due to the difference in density in the expandable microcapsules 110 and the surrounding area, the reflected sound waves can be used to image the fractures 60. The expandable microcapsules may similarly be used to map water flooding in a geological formation.

The present disclosure provides methods of preparing expandable microcapsules that allow for control of expansion temperature and expansion volume ratio. Through a one-step suspension polymerization, multiple components may be encapsulated within a microcapsule near quantitative yield. The liquids can be miscible or immiscible, which may affect the vapor pressure inside the microcapsule according to Raoult's or Dalton's law, respectively. In the case of miscible liquids, e.g., perfluorohexane and perfluoropentane, both the vapor pressure and the expansion temperature may be an average of the neat liquids, resulting in an expansion temperature within the boundaries corresponding to the pure liquids. For immiscible liquids, e.g., perfluoropentane and isopentane, the total vapor pressure may be a sum of the pressures of the neat liquids, which significantly lowers the expansion temperature below the temperatures of the neat perfluoropentane and isopentane, even at a low fraction of one of the components. In addition, the relative loading of each component in the expandable core may be used to tune the expansion volume ratio. For instance, in embodiments utilizing immiscible liquids, where one liquid may be non-volatile, the relative loading of each component in the expandable core may be used to tune the expansion volume ratio.

Embodiments of the present disclosure are further illustrated by the following examples, which are set forth to illustrate the presently disclosed subject matter and are not to be construed as limiting. The examples describe testing carried out to confirm the ability of embodiments of the present systems to deliver and release one or more materials under various conditions that exemplify various environments in which embodiments of the present systems may be utilized.

### Examples

The following examples illustrate systems and methods for preparing microcapsules of embodiments of the present disclosure. The examples illustrate expandable microcapsules comprising a polymeric shell and a multicomponent expandable core. The examples illustrate the relationship between the components of the multicomponent expandable core and properties such as expansion temperature and expansion volume ratio.

### Methods

Materials and Methods

The following materials were used: acrylonitrile (“AN,” Acros Organics, 99%+, stabilized with 40 ppm monomethyl ether hydroquinone), 1,1-dichloroethylene (“VDC,” Sigma Aldrich, stabilized with 200 ppm monomethyl ether hydroquinone as inhibitor), 2,2′-azobis(2-methylpropionitrile) (“AIBN,” Sigma Aldrich, 98%), trimethylolpropane triacrylate (“TMPTA,” Sigma Aldrich, stabilized with 100 ppm monomethyl ether hydroquinone), methacrylonitrile (“MAN,” Acros Organics, 99%, stabilized with 50 ppm monomethyl ether hydroquinone), Oil Red O (“ORO,” Sigma Aldrich), n-decane (“n-Dec,” Acros Organics, 99+%), perfluorohexane (“PFH”), perfluoropentane (“PFP”), perfluorooctane (“PFO”) (all from Sigma Aldrich, 99%), sodium hydroxide (NaOH, EM Science), magnesium chloride hexahydrate (MgCl₂.6H₂O, Mallinckrodt), and sodium 2-ethylhexylsulfate (Sigma Aldrich, ˜50% in water). AN and VDC inhibitors were removed by passing through a column of basic aluminum oxide (Sigma Aldrich). All materials are commercially available from the indicated source.

Polymerization

Polymeric microemulsions were synthesized using a suspension polymerization, in which the volatile compound(s) (e.g., hydrocarbon, perfluorocarbon and/or organic silanes) was encapsulated inside the polymeric shell. For instance, in an exemplary process utilizing perfluorohexane and decane (e.g., in the examples illustrating the control of the expansion volume ratio), the polymerization was performed according to the following procedure: a typical organic phase was prepared in a 4 mL Vialmix® vial including AIBN (0.010 g), AN (0.210 g), 10% TMPTA in AN solution (0.030 g), VDC (0.826 g), and 0.418 mL of PFH and decane dyed with 5.33×10⁻³ M ORO. The process was implemented at various PFH/n-decane ratios (see Table 1). A water phase was prepared in a 25 mL scintillation vial consisting of deionized water (12.86 g), NaOH (0.244 g), and MgCl₂.6H₂O (0.857 g). This mixture was stirred vigorously for 30 minutes, degassed, and 0.046 g of a 1% solution of sodium 2-ethylhexyl sulfate (aq) was added. The water phase (2.12 g) was added to the organic phase and the Vialmix® vial was sealed with a septa and cap using a Wheaton® E-Z Crimper™ and shaken three successive times on the Vialmix® to create a suspension. The suspension was then placed in the oven at 63° C. to polymerize for 16 hours. The product was passed through a 25 μm sieve and collected by vacuum filtration. Table 1 shows the composition of the core utilizing perfluorohexane and decane at various volumetric ratios. These compositions are discussed further in the examples illustrating the control of the expansion volume ratio.

For the case that water-soluble monomer (AA) was used as shell monomer, colloidal silica particles were used as a stabilizer together with PVP and K₂Cr₂O₇ (inhibits polymerization in the water phase) in the following manner: a typical organic phase included AIBN (0.006 g), AN (0.442 g), 1 wt % TMPTA in AN solution (0.01 g), AA (0.162 g) and 0.3 mL of core liquid components (certain ratio of PFH/n-decane) was mixed with a water phase including LUDOX HS-30 (0.03 g), 30 wt % PVP aqueous solution (0.02 g), 25 wt % K₂Cr₂O₇ aqueous solution (0.016 g) and deionized water (2 g). The pH of the water phase was adjusted to 4 by hydrochloric acid. The mixture was sealed and shaken in the same way above. Polymerization was processed at about 63° C. for about 12 hours.

TABLE 1
Composition of core is varied while shell is kept constant¹

| Shell monomers² | | | Core components⁴ | | | | |
|---|---|---|---|---|---|---|---|
| | 10 wt % | | PFH/n- | | | | |
| | TMPTA³ in | VDC | decane | n-decane | | | |
| AN (g) | AN (g) | (g) | (v/v %) | (g) | PFH (g) | AIBN⁵ (g) | Water⁶ (g) |
| 0.105 | 0.015 | 0.413 | 100/0 | 0.0000 | 0.3487 | 0.005 | 1.06 |
| 0.105 | 0.015 | 0.413 | 50/50 | 0.0763 | 0.1743 | 0.005 | 1.06 |
| 0.105 | 0.015 | 0.413 | 10/90 | 0.1372 | 0.0349 | 0.005 | 1.06 |
| 0.105 | 0.015 | 0.413 | 5/95 | 0.1449 | 0.0174 | 0.005 | 1.06 |
| 0.105 | 0.015 | 0.413 | 1/99 | 0.1510 | 0.0035 | 0.005 | 1.06 |
| 0.105 | 0.015 | 0.413 | 0/100 | 0.1525 | 0.0000 | 0.005 | 1.06 |

¹Total oil phase was kept constant of 0.696 mL, which consists of 70 vol % (0.487 mL) of shell monomers and 30 vol % (0.209 mL) of core components. The volume fraction of shell to core was varied from 90:10 to 30:70 (v/v %).
²AN/VDC ratio was varied from 0/100 to 100/0 (v/v %), typically AN/VDC = 30/70 was used.
³Crosslinking density was varied from 0 to 2.2 wt %; typically 0.28 wt % was used.
⁴Volume fraction of blowing agent (PFH) in a core varied from 0 to 100 vol %.
⁵[AIBN] = 1 wt % of monomers (g)
⁶Water phase = monomers (g) × 2

Optical Imaging with Heating

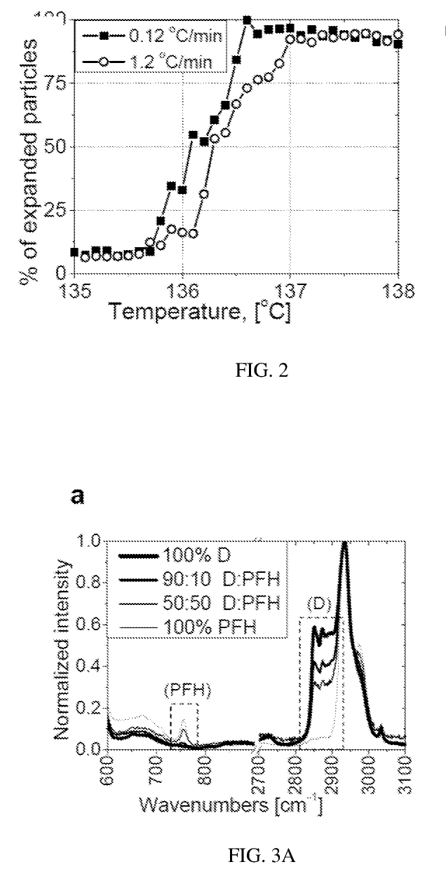

Unexpanded particles were heated on a glass slide to expansion using a Mettler FP82HT Hot stage at 6° C./minute during imaging. Images were taken once every 0.5° C. with an 18.0 megapixel DSLR (Canon 650D) attached to a Zeiss Axioskop 2 optical microscope. Using ImageJ software, frame-by-frame automated measurement of particle area allowed calculation of radius (R) and volume (V), assuming the particles to be spherical. Expansion curves were constructed by plotting the ratio of change in volume from the unexpanded volume (V/V₀) as a function of temperature, where no change in volume equals a value of one. The expansion temperature (Tₑₓₚ) was determined from the expansion curve as the temperature at which the volumetric expansion volume ratio starts deviating from a value of one. The temperature at which maximum volumetric expansion occurred (V/V₀_{_}ₘₐₓ) is the Tₘₐₓ. The rate of temperature increase was varied to determine optimum heating rates to ensure temperature and V/V₀ accuracy. For example, FIG. 2 illustrates expansion curves of VDC/AN capsules filled with PFH for two strongly different heating rates of 0.12° C./minute and 1.2° C./minute. The optimum heating rate may depend on the application and the environment in which the microcapsules are located. In some embodiments, larger expansion volumes may be achieved with faster heating rates (such as greater than 100° C./second). The optimal rate may be the fastest heating rate for the particular application and environment for the embodiment, although slower rates may still cause expansion.

SEM and FIB

Particle size was determined by scanning electron microscopy (“SEM”) using a FEI Helios 600 Nanolab Dual Beam System. Focused ion beam (“FIB”) milling of particles, to determine shell thickness, was done with gallium ions at 30 kV. A 10 nm gold-palladium coating was used to prevent charging and distortion of images.

Confocal Raman Microscopy

Confocal Raman microscopy was performed on unexpanded particles at ambient conditions to confirm the core composition. Samples were imaged using a Renishaw inVia Raman microscope: excited with a 514 nm laser at 0.1-0.5 mW; passed through a 1800 lines/mm grating; magnified with a 50× objective; 5-10 second exposure time per scan; 1-3 scans were averaged for one image. The spectra of six individual particles were averaged to form the spectrum of one type of formulation. For example, formulations with varying ratios of Decane:PFH as discussed in the examples illustrating the control of expansion volume ratio were tested.

### Results

Referring again to FIGS. 1A-1B, polymeric microcapsules were synthesized using a suspension polymerization, in which the volatile compound (hydrocarbon, perfluorocarbon, and/or organic silanes) was encapsulated inside the polymeric shell. FIGS. 1A-1B illustrate particles before (FIG. 1A) and after (FIG. 1B) expansion. Initially, the shell monomers, such as AN, VDC, and MAN, are present in the organic phase with the volatile core compound. This mixture is dispersed in the aqueous solution containing magnesium hydroxide stabilizers and surfactants. Acrylonitrile was used as one of the main components in the polymeric shell of the microcapsules. Acrylonitrile may exhibit excellent gas-barrier properties, yet, relatively poor heat-resistance. Copolymers of AN with other monomers, such as vinylidene chloride (“VDC”) and methacrylonitrile (“MAN”), were used for the polymer shell to ensure preparation of robust microcapsules.

As shown in FIGS. 1A-1B, expansion may occur when a microcapsule (see illustration (i) of FIG. 1A) containing a liquid blowing agent 2 is heated to a temperature (T) above the boiling temperature of the core liquid T_{b} (i.e., T>T_{b}) and the glass transition temperature of the shell material T_{g} (i.e., T>T_{g}), inflating it into a microbubble (see illustration (i) of FIG. 1B) filled with a gas 3 and with a larger diameter. Image (ii) of FIG. 1A and image (ii) of FIG. 1B show microcapsules in water and illustrate the decrease in density for expanded microcapsules. Image (iii) of FIG. 1A and image (iii) of FIG. 1B are SEM images at equal scale of a 100% PFH composition. These images illustrate the size increase of 10 μm for unexpanded microcapsules (see image (iii) of FIG. 1A) to 50 μm for expanded microcapsules (see image (iii) of FIG. 1B). Image (iv) of FIG. 1A and image (iv) of FIG. 1B are SEM images of FIB milled particles, and reveal the decrease in shell thickness (h) from 3 μm in unexpanded microcapsules (see image (iv) of FIG. 1A) to 80 nm in expanded microcapsules (see image (iv) of FIG. 1B) with a 100% PFH formulation.

Control of Expansion Volume Ratio

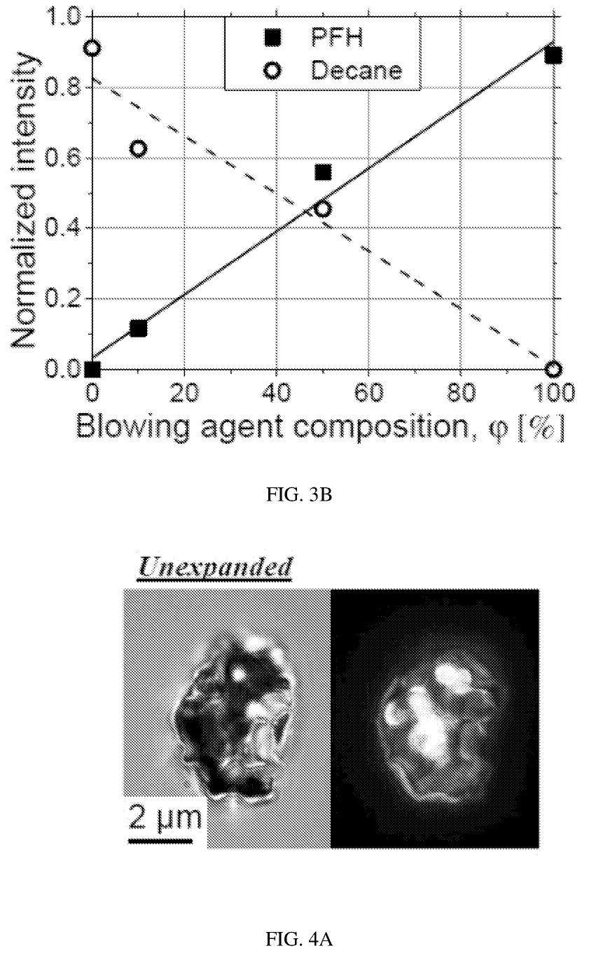

Two techniques to monitor the core composition inside individual microcapsules were used. Using confocal Raman microscopy, the intensity was measured for two distinct Raman bands at 761 cm⁻¹ and 2840 cm⁻¹ that correspond to perfluorohexane (“PFH”) and n-decane (“D”), respectively. FIG. 3A is a Raman spectra of individual polymeric microcapsules, and FIG. 3B is the analysis of the representative Raman peaks of FIG. 3A indicating the amount of perfluorohexane and decane in the core as a function of core composition. Each spectrum represents the average of six microcapsules.

The variations of the intensity ratio are consistent with the corresponding variation of the core composition. In addition, Red-oil dye (which is soluble in n-decane and exhibits strong fluorescent emission around 600 nm) was added to the n-decane liquid solution prior to emulsification and polymerization. In this example, the core composition had an approximate ratio of 5:95 liquid PFH 1 to liquid n-decane 2.

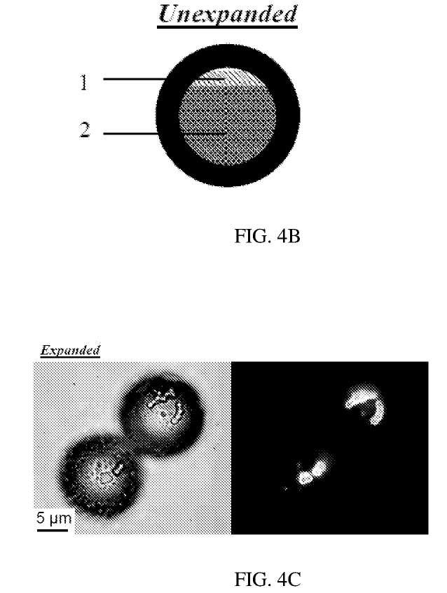

Referring to FIGS. 4A-4D, using three-dimensional fluorescence microscopy, successful encapsulation of the additional compound was confirmed. FIGS. 4A and 4C illustrate bright field (left image) and fluorescent (right image) microscopic images depicting the location of n-decane droplets within a core structure of unexpanded (FIG. 4A) and expanded (FIG. 4C) microcapsules. In addition, the selective solubility of Red-oil dye in n-decane allows imaging of the microcapsule internal structure before and after expansion. The relative volume of each component in the exemplary embodiment of FIGS. 4A-4D is illustrated in FIGS. 4B and 4D. In this exemplary embodiment, the relative volume of perfluorohexane (“PFH”) gas 3 as compared to n-decane liquid 4 changes dramatically upon expansion. The change in shell thickness is also apparent in FIGS. 4A-4D.

FIGS. 5A-5C illustrate the variation of the blowing agent content, φ and its effect on expandable properties of the polymeric microcapsules. FIG. 5A provides optical (left images) and SEM images (right images). FIG. 5B illustrates expansion curves as a function of φ. Expansion was measured with microcapsules comprising 1%, 5%, 10%, 50%, and 100% by volume perfluorohexane (“PFH”). FIG. 5C illustrates the dependence of maximum expansion (expansion ratio) and shell thickness (thinning) on φ. FIG. 5A shows expansion of polymeric microcapsule with different volume fractions (5%, 10%, 100%) of blowing agent (“PFH”). The optical images in FIG. 5A clearly show the changes in expandability by varying the perfluorohexane (“PFH”) content from 5 vol % to 100 vol %, which indicates that perfluorohexane and n-decane are co-encapsulated during polymerization. The expansion process starts at an expansion temperature of about 136° C. (see FIG. 5B), which is above both the boiling temperature of perfluorohexane (T_{b}=56° C.) and the glass transition temperature of the shell material (T_{g}=80° C.). See U.S. Pat. No. 3,615,972; and Y. Kawaguchi et al., Polym. Eng. Sci. 2009, 50, 835. The higher temperature generates sufficient vapor pressure to overcome the elasticity of the shell.

In the exemplary embodiment of FIGS. 5A-5C, and as shown in FIG. 5B, the expansion temperature does not depend on the loading of n-decane. In this exemplary embodiment, n-decane has a lower vapor pressure of 295 Pa (140° C.) compared to 8.9×10⁵ Pa (140° C.) of perfluorohexane. The significantly lower vapor pressure may result in a negligible effect on the total vapor pressure inside the shell according to Dalton's law.

In the exemplary embodiment of FIGS. 5A-5C, the expansion volume ratio (V/V₀) can be controlled by varying the molar fraction of perfluorohexane (blowing agent) in the core. FIG. 5C combines two log-log plots corresponding to volume expansion and shell thinning with increasing mass fraction of perfluorohexane. The volumetric expansion volume ratio (V/V₀) may increase linearly with the fraction of the blowing agent. In the exemplary embodiment of FIGS. 5A-5C, the volumetric expansion volume ratio may increase linearly up to 6% blowing agent. At higher fractions, the expansion volume ratio may deviate from linear dependence due to finite extensibility of the shell. The underestimation of the expansion volume ratio at high PFH fractions may be due to gas effusion through the progressively thin shell.

The second set of data points in FIG. 5C corresponds to average shell thickness determined by FIB sectioning of individual microcapsules. The linear fit follows a power law of h˜φ^{-0.56±0.12}, which demonstrates a good agreement with the theoretical φ^{-2/3}.

Controlling the Expansion Temperature

The onset of an expansion process may correspond to a system where the internal pressure (Pᵢₙ) exceeds the sum of the external pressure (Pₑₓₜ) and the restoring pressure (Pₑₗ) due to shell expansion (Pᵢₙ>Pₑₓₜ+Pₑₗ). The expansion temperature may depend on both shell properties and core composition. To shift the expansion onset, polymeric microcapsules containing two blowing agents that contribute to the total vapor pressure inside the shell were studied. Two systems were considered separately: (i) miscible liquids and (ii) immiscible liquids. To characterize the individual contributions, the expansion behavior of microcapsules with neat liquids in the core was also studied.

Neat Liquids

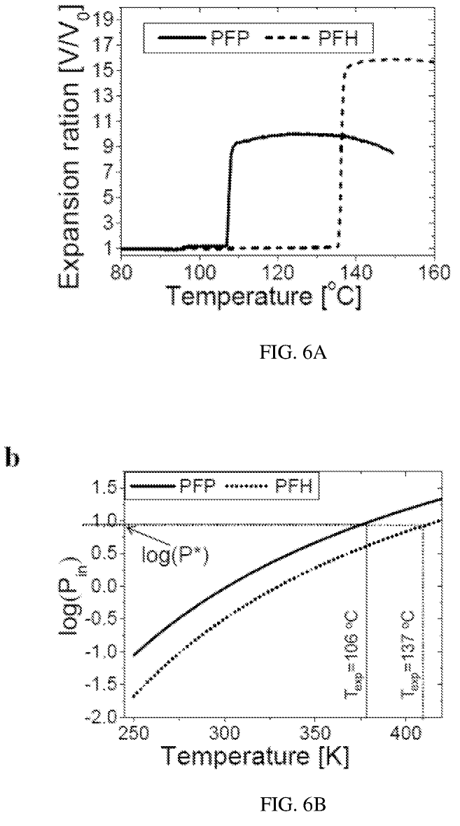

FIG. 6A is an expansion curve for perfluoropentane (“PFP”) and perfluorohexane (“PFH”), showing that the expansion temperature Tₑₓₚ changes depending on the volatility of the blowing agent. FIG. 6B is a liquid-vapor phase transition diagram for PFH and PFP showing that although they have different Tₑₓₚ, PFP and PFH core particles both expand when the vapor pressure reaches 6 atm.

Different blowing agents (perfluorohexane, perfluoropentane, perfluorooctane, isopentane, decane, hexane, tetramethylsilane) were incorporated into the same polymeric shell poly(AN-c-VDC). It was found that the triggering temperature (Tₑₓₚ) for the expansion process strongly depends on the core composition. FIG. 6A shows that microcapsules with the same shell composition and thickness exhibit different expansion temperatures: Tₑₓₚ=106° C. for perfluoropentane (“PFP”) and Tₑₓₚ=135° C. for perfluorohexane (“PFH”). Perfluorooctane exhibits an expansion temperature of 180° C. with the same shell composition and thickness. As shown in FIG. 6B, these temperatures correspond to the same vapor pressure of atm. In other words, neat perfluoropentane (“PFP”) at Tₑₓₚ=106° C. and neat perfluorohexane (“PFH”) at Tₑₓₚ=137° C. reach the same value P=6.8 atm, which is a critical expansion pressure for this particular shell structure. These temperatures are significantly above the glass transition temperature T_{g}=80° C. for this particular shell composition, and above the corresponding boiling temperatures, ranging from 28° C. for perfluoropentane to 102° C. for perfluorooctane.

Miscible Liquids

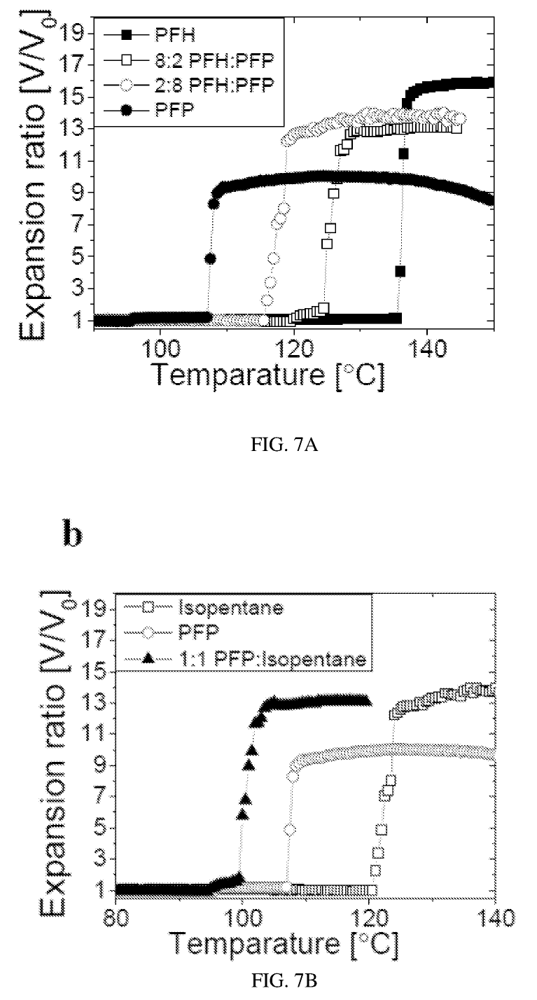

An initial synthetic step included encapsulation of the mixture of the miscible fluids such as perfluoropentane and perfluorohexane. The effect of core content followed Raoult's law, which states that that the total vapor pressure of an ideal solution is directly dependent on the vapor pressure of each chemical component and the mole fraction of the component present in the mixture. FIG. 7A illustrates an expansion curve of multicomponent cores with the same shell composition and miscible core components. As shown in FIG. 7A, the expansion temperature was varied over a wide range (106° C. to 138° C.) by alternating the core composition composed of ratios of perfluoropentane (“PFP”) and perfluorohexane (“PFH”), while maintaining the expansion pressure of P*=6.8±0.2 atm for all core compositions studied. The phase diagram based on Clayperon-Klausius equation predicts the dependence of vapor pressure as a function of temperature for different ratios of core components. The variation of core by altering the fraction of two miscible components allows accurate tuning of the expansion temperature.

Immiscible Liquids

For the immiscible system, a mixture of isopentane and perfluorohexane (the blowing agent) was studied. FIG. 7B is an expansion curve of multicomponent cores with the same shell composition and immiscible core components. The approach includes the step of encapsulation of two immiscible fluids within a polymeric shell. The expandable microcapsules encapsulating immiscible liquids may exhibit expandable properties when heated above the glass transition temperature. In an immiscible mixture, the partial pressure of a component is equal to the vapor pressure of the pure component. An ideal immiscible mixture obeys Dalton's law: Pₜₒₜₐₗ=P_{A}^{°}+P_{B}^{°}, where P_{A}^{°} and P_{B}^{°} are the vapor pressures of pure A and pure B. The total vapor pressure of the mixture will be greater than the vapor pressure of the pure components, and may not depend on the molar fractions of the individual pure components. The expansion temperature of the mixture will be lower when compared to the expansion temperature of the pure individual components. FIG. 7B illustrates this trend, which shows the expansion of microcapsules with ratios of isopentane and perfluoropentane (“PFP”) in the core. As shown in FIG. 7B, the expansion temperature of these capsules is below that of capsules with the neat liquids. Moreover, the expansion temperature may not depend on the relative loading (ratio) of the two components. This behavior is in contrast to microcapsules with miscible liquids in the core, which obey Raoult's law resulting in a higher expansion (see FIG. 7A).

Many modifications and other embodiments of the disclosures set forth herein will come to mind to one skilled in the art to which these disclosures pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described. All publications and patent applications are herein incorporated by reference to the same extent as if each individual publication or patent application was specifically and individually indicated to be incorporated by reference.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the terms “approximately” and “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D. The term “comprising,” which is synonymous with “including,” “containing,” or “characterized by,” is inclusive or open-ended and does not exclude additional, unrecited elements or method steps. “Comprising” is a term of art used in claim language which means that the named elements are present, but other elements can be added and still form a construct or method within the scope of the claim.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

While the compositions and methods of this invention have been described in terms of described embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a defacto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

All publications, patents, and patent applications are herein incorporated by reference to the same extent as if each individual publication, patent, or patent application was specifically and individually indicated to be incorporated by reference.

What is claimed is:

1. A method of acoustically imaging geological reservoirs comprising:
injecting expandable microcapsules into a geological reservoir;
propagating sound waves through the geological reservoir;
receiving sound waves reflected off the expandable microcapsules; and
creating an image of the sound waves reflected off the expandable microcapsules.

2. The method of acoustically imaging geological reservoirs according to claim 1, wherein the expandable microcapsules comprise a polymeric shell encapsulating two or more components with at least one component being a blowing agent.

3. The method of acoustically imaging geological reservoirs according to claim 1, wherein the geological reservoir is an oil and/or gas wellbore connected to an oil and/or gas-bearing formation.

4. The method of acoustically imaging geological reservoirs according to claim 3, further comprising dispersing the expandable microcapsules in a fluid.

5. The method of acoustically imaging geological reservoirs according to claim 4, further comprising pressurizing the fluid to create fractures in the oil and/or gas-bearing formation.

6. The method of acoustically imaging geological reservoirs according to claim 5, further comprising dispersing the fluid in the fractures created in the oil and/or gas-bearing formation.

7. An expandable microcapsule comprising:
a polymeric shell; and
a multicomponent expandable core comprising at least one blowing agent, wherein the expandable microcapsule expands at an expansion temperature.

8. The expandable microcapsule of claim 7, wherein the blowing agent comprises one or more of hydrocarbons, perfluorocarbons, and organic silanes.

9. The expandable microcapsule of claim 7, wherein the expandable core comprises one or more non-volatile components.

10. The expandable microcapsule of claim 7, wherein the expandable core comprises two or more blowing agents.

11. The expandable microcapsule of claim 7, wherein the expandable core comprises a liquid that is miscible with the blowing agent.

12. The expandable microcapsule of claim 7, wherein the expandable core comprises a liquid that is immiscible with the blowing agent.

13. The expandable microcapsule of claim 7, wherein the expandable core comprises one or more pharmaceutical drug, acid, base, lubricant, contrast agent, reactive chemical, density compensator, solids, or combinations thereof.

14. The expandable microcapsule of claim 7, wherein the expansion temperature is from about 50° C. to about 250° C.

15. The expandable microcapsule of claim 7, wherein the expansion temperature is less than about 100° C.

16. The expandable microcapsule of claim 7, wherein a ratio of a volume of the expandable microcapsule after expansion to a volume of the expandable microcapsule prior to expansion is about 30:1.
